(19) United States
(12) Patent Application Publication
(10) Pub. No.: US 2004/0008956 A1
(43) Pub. Date: Jan. 15, 2004

(54) Method of producing an optical cable

(75) Inventors: Christian Frohne, Hannover (DE); Bernd Kleemann, Seelze (DE); Klaus Porcher, Lehrte (DE); Tom Eirik Toften, Fauske (NO)

Correspondence Address: SUGHRUE MION, PLLC, 2100 Pennsylvania Avenue, NW, Washington, DC, 20037-3213, US

(73) Assignee: NEXANS

(21) Appl. No.: 10/387,408

(22) Filed: Mar. 14, 2003

(30) Foreign Application Priority Data
Mar. 16, 2002 (DE) 10211793.4

(51) Int. Cl. G02B 6/44

(52) U.S. Cl. 385/100

(57) ABSTRACT

A method for producing an optical cable with a metal tube and at least one optical fiber arranged in the metal tube, wherein optical fiber(s) are inserted into a slotted tube, the longitudinal slot in the slotted tube is welded, and the diameter of the welded tube is reduced. After the reducing operation, the welded tube is gripped by a draw-off device and conveyed in the finishing direction and wound up onto a draw-off disk. Between the draw-off device (10) and the draw-off disk (11), a force which causes elastic elongation of the metal tube (13) in the finishing direction is applied by the draw-off disk (11), and the extent of the elastic elongation is regulated through this force.

This application is based on and claims the benefit of German Patent Application No. 10211793.4 filed Mar. 16, 2002, which is incorporated by reference herein.

### BACKGROUND OF THE INVENTION

This invention relates to a method of producing an optical cable, with a metal tube and at least one optical fiber arranged in a metal tube, and to device for producing an optical cable.

European Patent Application 0 703 478 A describes a method of producing an optical cable comprising a metal tube in which is arranged at least one optical fiber. With this method, a metal strip is pulled off from a supply coil and shaped continuously by a strip-shaping device to form a slotted tube. At least one optical fiber is inserted into the slotted tube, which is still open, and the longitudinal slot in the metal is closed by a weld. The diameter of the welded tube is then reduced, whereby the force required to reduce the tube is applied by a draw-off device situated downstream from the tube reducing device. Downstream from the draw-off device, as seen in the direction of finishing, the metal tube with the optical fiber(s) situated inside it is wound with at least one winding onto a draw-off disk and then is coiled onto a supply coil.

The excess length of optical fiber, which is required with optical fiber cables, is produced with the known method by the fact that between the draw-off device and the draw-off disk, a force is made to act on the metal tube perpendicular to the direction of finishing, causing elastic deformation of the metal tube. The force is applied by a weight, which is suspended from the metal tube by means of a roll, causing it to deflect. The elastic elongation of the metal tube which occurs between the draw-off device and the draw-off disk because of this weight is eliminated on the tightening disk, thus causing the desired excess length.

It has proven to be a disadvantage of this known method that first, the force acting on the metal tube cannot be regulated, and therefore, it is impossible to adjust the excess length as the properties of the material change, and second, due to the deflection of the metal tube, a corkscrew-like stress is incorporated into it, which is a disadvantage in further processing of the optical cable.

### SUMMARY OF THE INVENTION

Based on the known method according to European Patent 0 703 478, the object of this invention is therefore to provide a method with which the excess length of the optical fiber can be adjusted accurately with respect to the metal tube and with which this corkscrew effect does not occur.

This object is achieved through a method wherein a force producing an elastic elongation of the metal tube in the direction of finishing is applied by the draw-off disk between the draw-off device and the draw-off disk, and the extent of the elastic elongation is regulated through this force.

The object of the invention is further achieved by a device for producing an optical cable, comprising a device which continuously shapes a metal strip into a tube, a welding device which closes the longitudinal slot in the tube and is part of a tube reducing device set up downstream from the welding device, a draw-off device which grips the welded tube whose diameter has been reduced, and a draw-off disk, with a drive motor for the draw-off disk, wherein a torque sensor is situated on the shaft connecting the drive motor and the draw-off disk.

Other advantageous features of the invention are described below and in the appended claims.

### BRIEF DESCRIPTION OF THE DRAWINGS

This invention is explained in greater detail on the basis of the exemplary embodiments illustrated schematically in FIGS. 1 through 3, wherein:

FIG. 1 shows a side view of the device according to this invention;

FIG. 2 shows a force measuring arrangement wherein the housing and/or the frame 11a of the draw-off disk 11 are mounted on two force measuring sensors 12a and 12b; and

FIG. 3 shows a force measuring arrangement wherein the draw-off disk 11 with its drive motor 14 are mounted on a bearing block which is in turn mounted on one or more force measuring sensors 17.

### DETAILED DESCRIPTION OF THE INVENTION

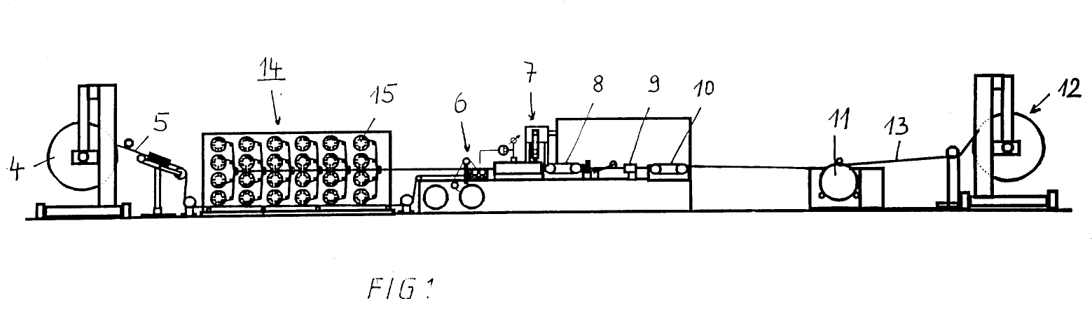

FIG. 1 shows a side view of the device according to this invention. A strip 5 is pulled off continuously from a supply coil 4 and sent to a shaping device 6, where the strip 5 is shaped into a tube with a longitudinal slot. Part of this shaping device 6 is a trimming device, in which the strip 5 is cut exactly to the required width. Shaping device 6 also consists of several sets of shaping rolls (not shown in detail). The longitudinal slot in the shaped tube is closed by means of a laser welding device 7. For accurate guidance of the slotted tube beneath the welding device 7, there is a first clamping jaw draw-off 8 consisting of a plurality of clamping jaw pairs encompassing the tube and driven by a continuous chain. A tube reducing device 9, e.g., a drawing mold where the diameter of the tube is reduced, is situated downstream from the first clamping jaw draw-off 8. Another clamping jaw draw-off 10 is situated downstream from the tube reducing device 9, acting on the drawn tube and drawing it through the drawing mold. Downstream from the second clamping jaw draw-off 10 are situated a drawing die (not shown) and a driven draw-off disk 11, to whose peripheral face the tube is applied with several windings. Draw-off disk 11 is driven at a draw-off speed that can be regulated relative to the draw-off speed of the second clamping jaw draw-off 10. A take-up stand 12, which coils up the tube 13 with a slight tension, is situated downstream from draw-off disk 11.

A take-off device for a plurality of optical fibers (not shown in detail here) is labeled as 14 here and has a plurality of coils 15 on which the optical fibers are wound.

Upstream from the welding device, the optical fibers are unwound from the coils 15 and inserted into the tube, which is still open. As protection for the sensitive optical fibers, a stationary metal tube (not shown) projects into the slotted tube, so that the optical fibers are passed through its interior. The metal tube releases the optical fibers from the welding device 7 immediately downstream. The metal tube is surrounded by another metal tube in a concentric arrangement. A petroleum jelly is introduced under pressure into the tube through the annular gap formed by the two concentric metal tubes.

In order for the optical fiber in the metal tube to be provided with an excess length, the metal tube is gripped continuously between the second clamping jaw draw-off 10 whose clamping jaw pairs grip the metal tube securely and apply the deforming forces which occur due to the tube reduction, and the draw-off disk 11 undergoes elastic deformation, i.e., it is stretched. Therefore, equal lengths of stretched metal tube and optical fiber are wound onto the draw-off disk 11. The state of elastic deformation “relaxes” on the draw-off disk 11 and the metal tube is shortened to the normal condition.

The elastic deformation is produced by the fact that the draw-off disk 11 exerts a force on the metal tube between clamping jaw draw-off 10 and draw-off disk 11 in the finishing direction. In order for the force to always remain constant and thus produce a constant excess length of the optical fibers in the metal tube, the force is measured and is input as a determining quantity in a control circuit, which regulates the rate of rotation of the draw-off disk.

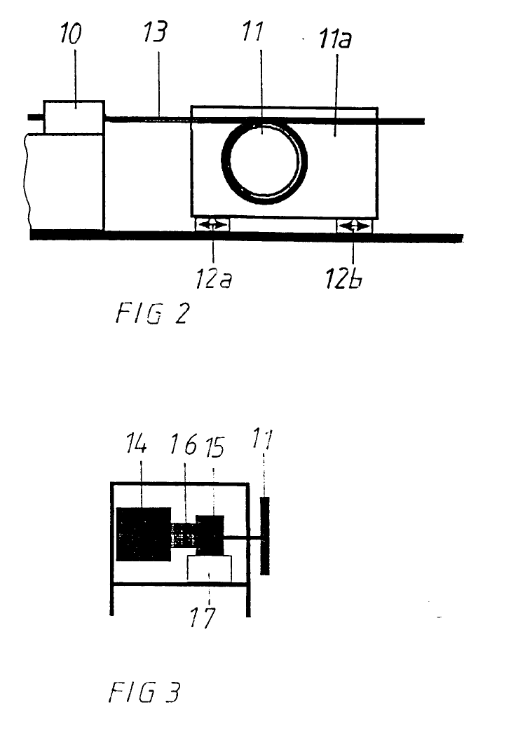

FIGS. 2 and 3 show two especially simple options for measuring the force.

In FIG. 2 the housing and/or the frame 11a of the draw-off disk 11 is mounted on two force measuring sensors 12a and 12b.

FIG. 3 shows the draw-off disk 11 with its drive motor 14 and a bearing block 15 illustrated schematically, as seen in the direction of finishing.

A first possibility of measuring the force consists of the bearing block 15 being mounted on one or more force measuring sensors 17. If there is no bearing block 15, the drive motor 14 may be mounted on force measuring sensors in a manner not shown here.

In the second measurement method, between the drive motor 14 and the draw-off disk 11, a torsion sensor (not shown here) is arranged on the shaft 16 connecting the drive motor 14 and the draw-off disk 11.

What is claimed is:

1. A method of producing an optical cable having a metal tube and at least one optical fiber situated in the metal tube, whereby a metal strip which is pulled off from a supply coil is gradually shaped into a slotted tube; while this slotted tube is still open, one or more optical fibers are inserted into the slotted tube; the longitudinal slot in the slotted tube is welded, and the diameter of the welded tube is reduced, the welded tube is gripped by a draw-off device after the reducing operation and is conveyed in the finishing direction and wound onto a draw-off disk with at least one winding, wherein a force producing an elastic elongation of the metal tube in the direction of finishing is applied by the draw-off disk between the draw-off device and the draw-off disk, and the extent of the elastic elongation is regulated through this force.

2. The method according to claim 1, wherein the force produced by the draw-off disk is measured by one or more force measuring sensors.

3. The method according to claim 1, wherein the torque of the drive from the draw-off disk is measured by a torsion sensor, for example.

4. The method according to claim 1, wherein the force acting on the draw-off disk and/or the housing/frame of the draw-off disk is measured.

5. A device for producing an optical cable having a metal tube and at least one optical fiber situated in the metal tube, comprising a device which continuously shapes a metal strip into a tube, a welding device which closes the longitudinal slot in the tube and is part of a tube reducing device set up downstream from the welding device, a draw-off device which grips the welded tube whose diameter has been reduced, and a draw-off disk, wherein the draw-off disk is mounted on force measuring sensors where the values determined by the force measuring sensors are the controlled variables for the drive of the draw-off disk (11).

6. A device for producing an optical cable having a metal tube and at least one optical fiber situated in the metal tube, comprising a device which continuously shapes a metal strip into a tube, a welding device which closes the longitudinal slot in the tube and is part of a tube reducing device set up downstream from the welding device, a draw-off device which grips the welded tube whose diameter has been reduced, and a draw-off disk, with a drive motor for the draw-off disk, wherein a torque sensor is situated on the shaft connecting the drive motor and the draw-off disk.

7. A device for producing an optical cable having a metal tube and at least one optical fiber situated in the metal tube, comprising a device which continuously shapes a metal strip into a tube, a welding device which closes the longitudinal slot in the tube and is part of a tube reducing device set up downstream from the welding device, a draw-off device which grips the welded tube whose diameter has been reduced, and a draw-off disk, with a drive motor for the draw-off disk, wherein at least one of (i) the drive motor and (ii) a bearing block provided between the drive motor and the draw-off disk, are mounted on force measuring sensors (17).
